(19) United States
(12) Patent Application Publication
(10) Pub. No.: US 2023/0057997 A1
(43) Pub. Date: Feb. 23, 2023

(54) THREADED FASTENING SYSTEM

(71) Applicant: Corey L. Schaub, Traverse City, MI (US)

(72) Inventor: Corey L. Schaub, Traverse City, MI (US)

(21) Appl. No.: 17/405,277

(22) Filed: Aug. 18, 2021

(51) Int. Cl. F16B 33/00; F16B 35/04; F16B 37/00; F16B 35/06

(52) U.S. Cl. CPC F16B 33/002; F16B 35/041; F16B 37/00; F16B 35/06

(57) ABSTRACT

A fastener system incorporated in a structural member, the system including a dual threaded member and an anti-rotational member. The dual threaded member is inserted through a hole in the structural member. The dual threaded member has an engaging feature. The anti-rotational member is coupled to the dual threaded member, and the anti-rotational member is coupled with the engaging feature of the dual threaded member and with the structural member to thereby limit rotation of the dual threaded member relative to the structural member.

### 1. FIELD OF THE INVENTION

The present invention relates to fasteners, and, more particularly, to a fastener used to receive another fastener that may have a coupling feature.

### 2. DESCRIPTION OF THE RELATED ART

A threaded fastener is a hardware device that mechanically affixes objects together or provides a connecting feature. In general, threaded fasteners are used to create non-permanent joints, which can be removed or dismantled.

Threaded fasteners have a section along the length that has a thread formed thereon. The thread has a pitch, a major diameter and a minor diameter. The threaded portion is mated to a reciprocally formed threaded item by rotating the two relative to each other.

Threaded fasteners often have a head on one end so that the fastener will engage a surface through which a portion of the fastener is passed. Typically, a nut or other female threaded item is used on the threaded end of the fastener to draw the fastener to the item to which it is affixed. The head engages one surface and the nut generally engages an opposite surface, either or both can be configured to be driven by a driver or a wrench that engages a feature on the head and/or nut.

A lock washer or a lock nut is often used with a bolt so that the bolt and nut remain engaged with each other. However, this arrangement allows the bolt to be rotated relative to structure to which it is affixed. Practical evidence of this is widespread in that two wrenches are then required to remove or affix the bolt to the structure.

In particular applications, such as in marine applications it is often desirable to have a threaded connection point to which a coupling feature, such as an eyebolt, is threaded into the threaded connection point. This then makes the eyebolt useful for attaching a pulley or a rope etc. thereto. The removal of the eyebolt is then desired when the coupling feature is no longer needed. A problem can arise if the eyebolt loosens the threaded connection point.

What is needed in the art is a fastener system that is versatile and provides a non-loosening threaded connection point.

### SUMMARY OF THE INVENTION

The present invention provides a fastener system that is engaged with a structural member, the fastener system being non-rotatable when installed.

The invention in one form is directed to a fastener system incorporated in a structural member, the system including a dual threaded member and an anti-rotational member. The dual threaded member is inserted through a hole in the structural member. The dual threaded member has an engaging feature. The anti-rotational member is coupled to the dual threaded member, and the anti-rotational member is coupled with the engaging feature of the dual threaded member and with the structural member to thereby limit rotation of the dual threaded member relative to the structural member.

The invention in another form is directed to a fastener system configured to be incorporated in a structural member having a hole therein. The fastener system includes a dual threaded member and an anti-rotational member. The dual threaded member is insertable through the hole in the structural member. The dual threaded member has an engaging feature. The anti-rotational member is coupled to the dual threaded member, and the anti-rotational member is coupled with the engaging feature of the dual threaded member and with a surface of the structural member to thereby limit rotation of the dual threaded member relative to the structural member.

The invention in yet another form is directed to a method of fixing a fastener system to a structural member, the method comprising the steps of inserting, engaging a feature, threading, rotating, engaging a spur and threading a coupling member. The inserting step including inserting a dual threaded member into a hole in the structural member, with one end of the dual threaded member engaging a first surface of the structural member, an external threaded portion of the dual threaded member extending beyond a second surface of the structural member. The engaging a feature step including engaging a feature on the dual threaded member with an anti-rotational member that limits rotation of the dual threaded member relative to the anti-rotational member. The threading step including threading a nut onto the external threaded portion of the dual threaded member. The rotating step including rotating the nut thereby tightening the dual threaded member and the anti-rotational member to the structural member. The engaging a spur step including engaging a spur on the anti-rotational member to the second surface of the structural member thereby limiting movement of the anti-rotational member relative to the second surface of the structural member and by extension limiting the rotatability of the dual threaded member relative to the structural member. The treading a coupling member step including threading a coupling member into an internal threaded portion of the dual threaded member, the coupling member extending above the first surface of the structural member.

An advantage of the present invention is that once the fastening system is installed a threaded item can be threaded into the internal threads and removed without the fastening system rotating and loosening.

Another advantage of the present invention is that the engaging features of the dual threaded member and the anti-rotational member are complementary for easy fixing of the system to a structural member.

Yet another advantage of the present invention is that the location of the spur on the anti-rotational member provides a substantially leverage location to preclude disengagement when a threaded member is removed from the system.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exploded perspective view of a fastening system according to an embodiment of the present invention with an eyebolt coupled thereto;

FIG. 2 is an exploded perspective view of an embodiment of a fastening system kit using the fastening system of FIG. 1 shown additionally with a plug, a bolt and some washers;

FIG. 3 is a side cross sectional view of the fastening system of FIGS. 1 and 2 installed in a structural member;

FIG. 4 is a side cross sectional view of the fastening system of FIGS. 1 and 2 installed in a structural member and structural member support, the support being illustrated is an I-beam, shown in part;

FIG. 5 is a side cross sectional view of the fastening system of FIGS. 1 and 2 installed in a structural member and through a support tube;

FIG. 6 is a perspective view of an anti-rotational washer used in the fastening system of FIGS. 1-3;

FIG. 7 is a perspective view of a dual threaded member used in the fastening system of FIGS. 1-3; and

FIG. 8 is a perspective view of the plug screw used to preserve the internal threads of the fastening system of FIGS. 1-3.

Corresponding reference characters indicate corresponding parts throughout the several views. The exemplifications set out herein illustrates embodiments of the invention and such exemplifications are not to be construed as limiting the scope of the invention in any manner.

### DETAILED DESCRIPTION OF THE INVENTION

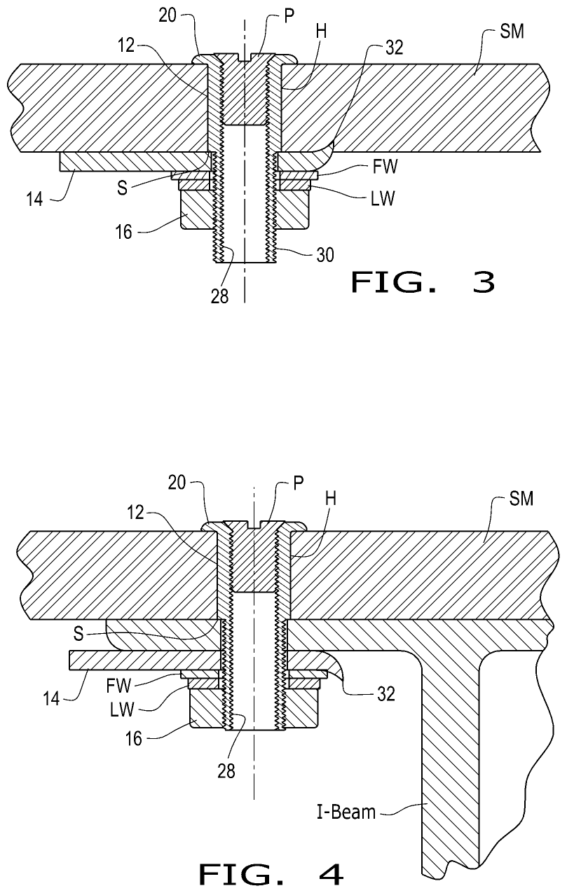

Referring to the drawings, and more particularly to FIG. 1, there is shown an embodiment of a fastener system 10 for incorporation in a hole H of a structural member SM (also see FIG. 3). Fastening system 10 includes a dual threaded member 12, an anti-rotational member 14, a flat washer FW, a lock washer LW and a nut 16. A coupling member 18, such as an eyebolt 18, is connectable to dual threaded member 12, so that another item, such as a pulley mechanism, not shown, can be hooked onto eyebolt 18.

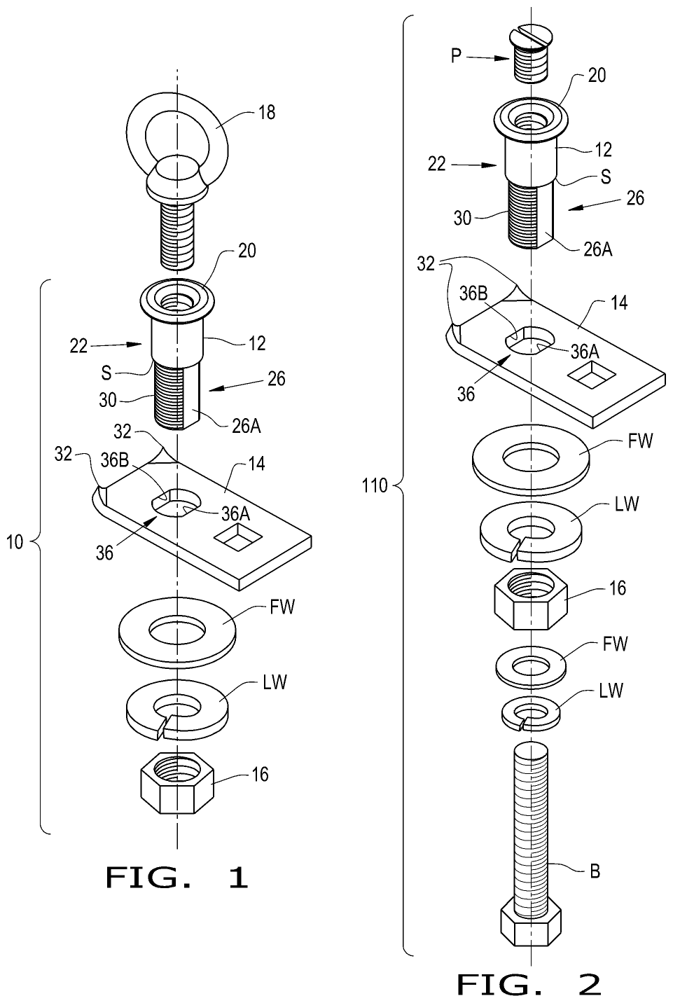

Now, additionally referring to FIG. 2, there is shown a fastener system kit 110, which includes each of the elements of fastener system 10, and additionally another flat washer FW, another lock washer LW, a plug screw P, and a bolt B. Kit 110 allows an installer to use the needed parts to apply to their particular installation, discussed herein.

Now, additionally referring to FIG. 3, there is illustrated an installation of one embodiment of fastener system 10 installed in structural member SM. Dual threaded member 12 (also see FIG. 7) has a head 20, a shaft 22, a through hole 24, an engaging feature 26, an engaging shoulder S, an internal threaded portion 28 and an external threaded portion 30. Through hole 24 is coaxial with shaft 22 and extends from an outer surface of head 20 through the entire longitudinal length of member 12. Internal threads 28 extend entirely through hole 24 allowing eyebolt 18, plug P and/or bolt B to be threaded thereinto. External threaded portion 30 is on an end of member 12 opposite head 20, and is interrupted by feature 26. In the example illustrated, feature 26 is in the form of flats 26A and 26B that interact with member 14 to preclude system 10 from rotating in member SM. Flats 26A and 26B are deep enough that they are below the major diameter or outer portion of threads 30. External threaded portion 30 is engaged by nut 16 drawing system 10 together to engage structural member SM, so that shoulder S of dual threaded member 12 comes into contact with member 14, the combination thereof causes system 10 to be non-rotational relative to structural member SM. As shoulder S contacts member 14 any compression or any further compression of structural member SM stops.

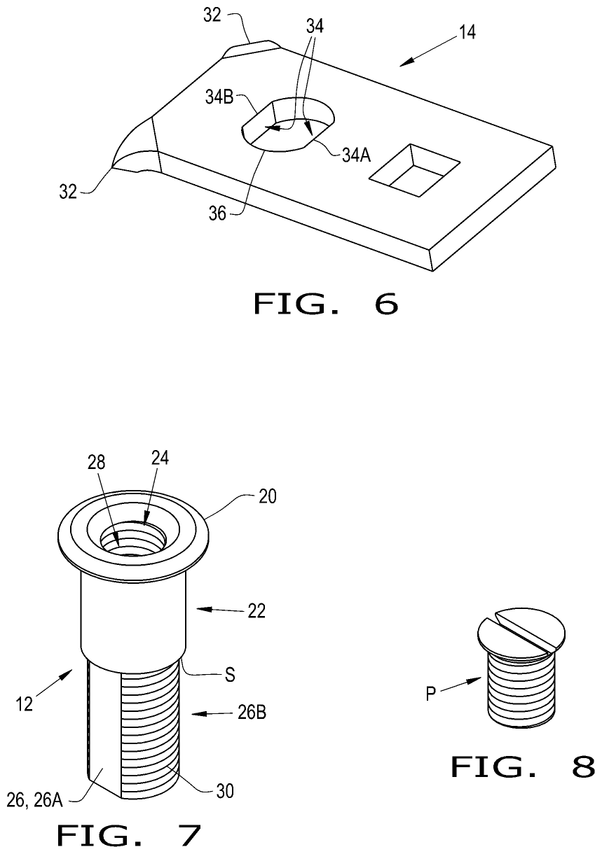

Anti-rotational member 14 (also see FIG. 6) has two major sides that are mirror images of each other except for spurs 32 or teeth 32 that extend on the side oriented toward a surface of structural member SM. Anti-rotational member 14 can be considered a washer 14, but unlike a common washer, member 14 extends away from a hole 36 so that teeth 32 engage with the surface of member SM, the extent providing a leveraged advantage to preclude rotational movement of anti-rotational member 14. Member 14 additionally has flat portions 34A and 34B along the sides of hole 36 that are complimentary to flats 26A and 26B of dual threaded member 12. When dual threaded member 12 is coupled to anti-rotational member 14 engaging features 26A and 26B contact flats 34A and 34B so that dual threaded member 12 will not rotate relative to anti-rotational member 14 and will also not rotate relative to structural member SM when system 10 is tightened in place. This can also be thought of as limiting rotation of dual threaded member 12 relative to structural member SM, so that when coupling feature 18 is unthreaded the torque applied to coupling feature 18 does not translate into a rotation of fastener system 10 or a loosening of member 12 relative to nut 16.

Engaging feature 26 may, as illustrated, extend below a minor thread diameter of external threaded portion 30 along at least one side of external threaded portion 30, or feature 26 may extend along threaded portion 30 only below the major thread diameter. Flats 26A and 26B run along at least one side of the external threaded portion. Torque that is applied to internal threaded portion 28 is resisted by system 10 by way of the coupling of flats 26A and 26B with flats 34A and 34B and the location of teeth 32 that are located proximate to corners 38 of anti-rotational member 14, and by the interaction of shoulder S against the metal of anti-rotational member 14 or other metal structure shoulder S encounters.

Now, additionally referring to FIG. 4 there is shown another way of using parts from kit 110 to install fastener system 10, here through a metal support, illustrated as a portion of an I-beam. In this application of fastener system 10 member 14 is flipped over so that teeth 32 don't contact any surface and shoulder S is resting on a portion of the I-beam. A typical installation on a boat, where support structural member SM is a wood floor SM and there is an aluminum cross member, which is, for purposes of illustration the I-beam. A 9/16″ hole is drilled through floor SM and a portion of the cross member, then an oversized hole of ⅝″ is drilled only through flooring SM. Dual-threaded member 12 is installed into the stepped hole, with member 14, flat washer FW, a lock washer LW and nut 16. As nut 16 is torqued to 35 ft-lbs. shoulder S bottoms on the cross member. While nut 16 is being tightened, fastener system 10 can be rotated so that anti-rotational member 14 rotates against a vertical portion of the I-beam to preclude further rotation.

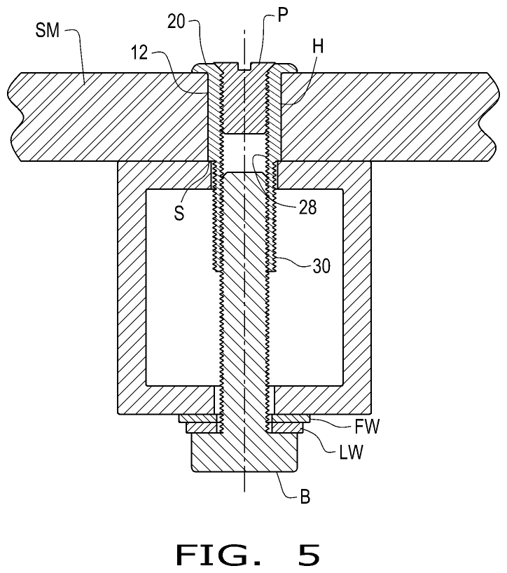

Now, additionally referring to FIG. 5 there is shown another way of using parts from kit 110 to install fastener system 10, here through an enclosed metal support, illustrated here as a square structural tube. In this application of fastener system 10 member 14 is omitted. A typical installation on a boat where support structural member SM is a wood floor SM and there is a tubular aluminum cross member, which is, for purposes of illustration the square tube. A 9/16″ hole is drilled through floor SM and through both sides of the square tube, then an oversized hole of ⅝″ is drilled only through flooring SM. Dual-threaded member 12 is installed into the stepped hole, with flat washer FW, a lock washer LW and bolt B is coupled to internal threads 28. As bolt B is torqued to 35 ft-lbs. shoulder S bottoms on the square tube. Blue thread locking agent can be used on the threads of bolt B.

FIGS. 6 and 7 are respectively perspective views of members 14 and 12, to illustrate features of these parts of kit 110.

In the event structural member SM is a composite floor or a carbon fiber floor or a fiberglass floor, system 10 can be installed through a ⅝″ hole. Then anti-rotational member 14 is installed with bonding agent applied between surfaces. Add the flat washer FW, lock washer LW and nut 16, and torque to 35 ft-lbs.

In the event structural member SM is thicker, say 2 inches or more, then Drill 7/16″ hole through entire structure. Follow with a 9/16″ drilling operation to 2″ depth. Followed with ⅝″ drilling to ¾″ depth. Install dual-threaded member 12 into the multi stepped hole with bonding agent such as epoxy on external threads 30 and side of ⅝″ member 12. Thread bolt B into member 12 with lock washer LW thereon and red thread locking agent on the bolt threads. Torque to 35 ft-lbs. for a permanent mounting. All dimensions are used for explanation purposes only and are not to be construed as limitations.

Now additionally referring to FIG. 8, there is shown a threaded plug P that can be threaded into through hole 24 to keep dirt, debris and moisture from easily entering through hole 24 and to preserve the integrity of internal threads 28, when system 10 is not engaged with a coupling member 18.

As can be visualized from the figures, a method of fixing fastener system to a structural member, takes place by inserting dual threaded member 12 into hole H of structural member SM. Head 20 is one end of dual threaded member 12 that engages a first surface of structural member SM. External threaded portion 30 of dual threaded member 12 extending beyond a second surface of structural member SM. An engaging takes place in which a feature 26 on the dual threaded member is engaged with feature 34 of anti-rotational member 14, which together limits rotation of dual threaded member 12 relative to anti-rotational member 14. A threading step takes place by threading a nut onto external threaded portion 30 of dual threaded member 12. A rotating step takes place in which nut 16 is rotated thereby tightening dual threaded member 12 and anti-rotational member 14 to structural member SM. The engaging a spur step takes place by engaging spur 32 on anti-rotational member 14 to the second surface of structural member SM thereby limiting movement of anti-rotational member 14 relative to the second surface of structural member SM and by extension limiting the rotatability of dual threaded member 12 relative to structural member SM. The threading a coupling member step takes place when coupling member 18 is threaded into internal threaded portion 28 of dual threaded member 12, with coupling member 18 extending above the first surface of structural member SM.

Advantageously, fastener system 10 of the present invention provides a secured, non-rotatable coupling point for many applications, including on vehicles of various types.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A fastener system incorporated in a structural member, comprising:
a dual threaded member, the dual threaded member being inserted through a hole in the structural member, the dual threaded member having an engaging feature; and
an anti-rotational member coupled to the dual threaded member, the anti-rotational member coupling with the engaging feature of the dual threaded member and with the structural member to thereby limit rotation of the dual threaded member relative to the structural member.

2. The fastener system of claim 1, wherein the dual threaded member has an internal threaded portion and an external threaded portion.

3. The fastener system of claim 2, wherein the dual threaded member has a shoulder against which the anti-rotational member contacts to stop additional compressing force against the structural member when a nut or a bolt is coupled with the dual threaded member for drawing a head of the dual threaded member and the anti-rotational member against opposite sides of the structural member.

4. The fastener system of claim 2, wherein the structural member is supported by a metal support, the dual threaded member having a shoulder against which the metal support contacts to stop additional compressing force against the structural member when a nut or a bolt is coupled with the dual threaded member for drawing a head of the dual threaded member and the metal support.

5. The fastener system of claim 2, wherein the engaging feature extends below a minor thread depth of the external threaded portion along at least one side of the external threaded portion.

6. The fastener system of claim 5, wherein the engaging feature is a flattened portion running along at least one side of the external threaded portion.

7. The fastener system of claim 6, wherein the anti-rotational member couples with the dual threaded member by having a least one complimentary flattened portion corresponding to the flattened portion of the dual threaded member.

8. The fastener system of claim 7, wherein the anti-rotational member has at least one spur to engage the structural member.

9. The fastener system of claim 8, further comprising a nut threaded to the external threaded portion, the nut drawing the dual threaded member tight against the structural member and the nut also drawing the anti-rotational member tight against a side of the structural member.

10. The fastener system of claim 9, wherein the at least one spur is located proximate to a corner of the anti-rotational member.

11. The fastener system of claim 2, wherein the internal threaded portion of the dual threaded member has a coupling member threaded thereto.

12. The fastener system of claim 11, wherein the coupling member is an eyebolt.

13. A fastener system kit for engaging a structural member by way of a hole in the structural member, the fastener system kit comprising:
a dual threaded member, the dual threaded member being for insertion through the hole in the structural member, the dual threaded member having an engaging feature; and
an anti-rotational member couplable to the dual threaded member, the anti-rotational member being couplable with the engaging feature of the dual threaded member and with the structural member to thereby limit rotation of the dual threaded member relative to the structural member.

14. The fastener system kit of claim 13, wherein the dual threaded member has an internal threaded portion and an external threaded portion.

15. The fastener system kit of claim 14, further comprising a nut couplable to the external threaded portion and/or a bolt couplable to the internal threaded portion.

16. The fastener system kit of claim 15, wherein the engaging feature extends along at least part of the external threaded portion.

17. The fastener system kit of claim 16, wherein the engaging feature is a flattened portion running along at least one side of the external threaded portion.

18. The fastener system kit of claim 17, wherein the anti-rotational member has a least one complimentary flattened portion corresponding to the flattened portion of the dual threaded member.

19. The fastener system kit of claim 18, wherein the anti-rotational member has at least one spur to engage the structural member.

20. A method of fixing a fastener system to a structural member, the method comprising the steps of:
inserting a dual threaded member into a hole in the structural member, with one end of the dual threaded member engaging a first surface of the structural member, an external threaded portion of the dual threaded member extending beyond a second surface of the structural member, the dual threaded member having a shoulder and a head;
engaging a feature on the dual threaded member with an anti-rotational member that limits rotation of the dual threaded member relative to the anti-rotational member;
threading a nut onto the external threaded portion of the dual threaded member;
rotating the nut thereby tightening the dual threaded member and the anti-rotational member to the structural member; and
engaging a spur on the anti-rotational member to the second surface of the structural member thereby limiting movement of the anti-rotational member relative to the second surface of the structural member and by extension limiting the rotatability of the dual threaded member relative to the structural member, the rotating step drawing the anti-rotational member toward the head until the shoulder contacts the anti-rotational member.
